(19) United States
(12) Patent Application Publication
(10) Pub. No.: US 2011/0282639 A1
(43) Pub. Date: Nov. 17, 2011

(54) Modeling of Non-Quasi-Static Effects During Hot Carrier Injection Programming of Non-Volatile Memory Cells

(75) Inventors: Borna Obradovic, McKinney, TX (US); Keith Green, Prosper, TX (US)

(73) Assignee: TEXAS INSTRUMENTS INCORPORATED, Dallas, TX (US)

(21) Appl. No.: 13/005,892

(22) Filed: Jan. 13, 2011

Related U.S. Application Data
(60) Provisional application No. 61/345,389, filed on May 17, 2010.

(51) Int. Cl. G06F 17/50

(52) U.S. Cl. 703/14

(57) ABSTRACT

A non-quasi-static model of the programming behavior of a floating-gate metal-oxide-semiconductor (MOS) transistor. This model is based on evaluation of a body current, for example determined as a function of voltages applied to the transistor from the circuit environment. The body current is used as an input to a non-quasi-static function on which the modeled gate injection current is based. In one example, the body current is applied to a representation of a series R-C circuit beginning from a time corresponding to the onset of avalanche breakdown, with the voltage across the capacitor serving as a control voltage of a voltage-controlled current source that drives the gate injection current. Integration of the gate injection current over the time interval of the programming pulse provides an estimate of the trapped charge at the floating gate.

### CROSS-REFERENCE TO RELATED APPLICATIONS

This application claims priority, under 35 U.S.C. §119(e), of Provisional Application No. 61/345,389, filed May 17, 2010, incorporated herein by this reference.

### STATEMENT REGARDING FEDERALLY SPONSORED RESEARCH OR DEVELOPMENT

Not applicable.

### BACKGROUND OF THE INVENTION

This invention is in the field of simulation of integrated circuits. Embodiments of this invention are more specifically directed to the simulation of integrated circuits including non-volatile memory cells programmed by the mechanism of hot carrier injection.

Non-volatile solid-state read/write memory devices are now commonplace in many electronic systems, particularly in portable electronic devices and systems. One common technology for realizing non-volatile solid-state memory devices involves the trapping of charge on a floating gate electrode in a metal-oxide-semiconductor (MOS) transistor to store programmed charge. Memories and memory elements of this type are referred to as floating-gate non-volatile memory (FG-NVM) devices. In these FG-NVM devices, the memory cell transistor is “programmed” by biasing it so that electrons are injected through a thin dielectric film onto an electrically isolated transistor gate element. The trapped electrons on the floating gate will lower the apparent threshold voltage of the memory cell transistor (for p-channel transistors), as compared with the threshold voltage with no electrons trapped on the floating gate. This difference is made apparent by different source-drain conduction under normal transistor bias conditions.

In one class of FG-NVM memories, commonly referred to as electrically erasable programmable “read-only” memories (i.e., EEPROMs), programming is performed by biasing memory cell transistors so that electrons tunnel to the floating gate; conversely, the memory cells are erased by applying a bias that removes the electrons from the floating gate, again by way of tunneling. In other classes of FG-NVM devices, including one-time programmable (OTP) memories, hot carrier injection serves as the programming mechanism. “Flash” memory devices refer to FG-NVM devices that are typically programmed by hot carrier injection, but that rely on a tunneling mechanism for the erase operation, with the erase bias applied simultaneously to a large number (a “block”) of memory cells.

One conventional example of hot carrier injection programmable FG-NVMs is shown in FIG. 1a, in which memory cell 5 is realized by the series combination of p-channel floating-gate metal-oxide semiconductor (MOS) transistor 2 and MOS select transistor 4. In this example, floating-gate transistor 2 has a single floating (i.e., electrically isolated) polysilicon gate electrode, while MOS transistor 4 has a gate receiving word line WL_ (in the context of a memory array). Typically, if transistor 2 is not programmed (i.e., does not have appreciable charged trapped at its floating-gate electrode), its threshold voltage will be sufficiently raised that it remains in an “off” state, blocking conduction between terminals V1, V2 even with select transistor 4 turned on. Conversely, if floating gate transistor 2 is programmed (i.e., has electrons trapped on its floating gate), its threshold voltage will be sufficiently low that the series combination of the two transistors 2, 4 will conduct between terminals V1, V2 under proper bias, while word line WL_ is energized (logic low level in this p-channel example). A sense amplifier (not shown) can sense the presence or absence of current from terminal V2, thus distinguishing the data state stored by cell 5.

In some OTP and flash memories, programming via hot carrier injection is induced by an avalanche situation caused by channel hot carrier (CHC) conduction. In this case, an example of which is shown in FIG. 1b, the programming bias consists of a high voltage applied to source S and body node (i.e., substrate or well) of transistor 2, with drain D at ground (or some lower voltage). The drain voltage capacitively couples to floating gate FG to such an extent that the channel of transistor 2 is weakly turned on. At sufficiently high drain-to-source voltage, carriers conducted in the channel have sufficient energy to cause impact ionization avalanching in the channel, typically nearer the drain end of the channel as shown in FIG. 1b. This avalanching has the effect of injecting electrons into and through the transistor gate dielectric, trapping electrons at the transistor floating gate. After removal of the programming bias, the threshold voltage of transistor 2 will be decreased by an amount corresponding to the number of trapped electrons on floating gate FG (or in its gate dielectric), which will increase the channel conduction of transistor 2 under source-drain bias relative to its erased state (i.e., no trapped electrons at floating gate F). This modulation in threshold voltage and thus channel conduction is sensed upon selection of cell 5, to read the stored data state.

Other avalanche based programming mechanisms are also known in the art. Furthermore, variations on the construction of cell 5 (for example, an n-channel floating gate MOS transistor) are known in the art. For example, other conventional FG-NVM cells are constructed as one-transistor (1-T) cells, and include both a floating gate electrode and also a control gate electrode overlying the floating gate. Other types of FG-NVM cells include single-gate electrode structures in which a portion of the gate electrode overlies a thinner gate oxide than do other portions.

In certain circuit applications, such as in “flash” memories, a reverse bias applied to the body node of MOS transistor 2 removes the trapped electrons from its floating gate FG, erasing the programmed state of transistor 2 (and in turn, cell 5). Cell 5 is also useful in so-called “one-time-programmable” (“OTP”) programmable read-only memories (ROMs), in which case no circuit function is provided to erase any programmed state. OTP ROMs are, of course, useful as replacement to mask-programmable ROMs, since OTP ROMs can be programmed in the field.

Computer-based simulation of the operation of electronic circuits is a staple task in the design of modern integrated circuits, even for the most simple of functions but especially as integrated circuit functionality has become more complex. Modern circuit simulation tools not only allow the circuit designer to ensure that the circuit carries out the intended function, but also enable the designer to evaluate the robustness of circuit operation over variations in temperature, signal levels, power supply voltages, and process parameters. A well-known circuit simulation program is the Simulation Program with Integrated Circuit Emphasis, commonly referred to as SPICE, originated at the Electronics Research Laboratory of the University of California, Berkeley. Many commercial versions of the SPICE program are now available in the industry, including several versions that are internal or proprietary to integrated circuit manufacturers.

According to SPICE-based circuit simulators, the circuit being simulated is expressed in terms of its elements such as resistors, transistors, capacitors, and the like. Each circuit element is associated with a model of its behavior (i.e., response to voltage or current stimuli), and is “connected” into the overall circuit simulation by specifying the circuit nodes to which it is connected. DC, AC, or transient analysis of the circuit is then performed by specifying any initial conditions (voltages, currents, stored charge etc.), as well as the variable or node of interest, for which the circuit response is to be analyzed. Higher level analysis of the circuit, for example noise analysis, transfer functions, and the like, can also be performed via such simulation.

The models used for semiconductor devices in the simulation can be relatively simple circuit-based models, for example corresponding to the well-known Ebers-Moll or Gummel-Poon models. However, models based on device physics have now been derived that determine the device electrical characteristics according to physical parameters such as channel width, channel length, film or layer thicknesses, proximity to other devices, and the like. Such physical models can be correlated or combined with complex empirical electrical models derived from curve fitting to actual device electrical measurements, further improving (at least in theory) the precision with which the behavior of the circuit element can be simulated.

Typically, those device models that are defined largely by device physics parameters are especially useful in “analog” simulation of specific circuit functions, such as sense amplifiers. Other simulations, such as logic simulation of larger functions in the integrated circuit, typically do not require the precision of complex physical and empirical device models.

As with other circuit elements in modern integrated circuits, non-volatile memory cells such as cell 5 of FIG. 1a are conventionally modeled in this manner, to enable simulation of the operation of the integrated circuit. According to conventional models, hot carrier injection programming as described above is modeled according to a “lucky electron” model, as described in Hu, “Lucky-electron model of channel hot electron emission,” 1979 International Electron Devices Meeting, Paper 10.1109, (IEEE, 1979), pp. 22-25, incorporated by reference. As described in that article, the “lucky electron” model determines the probability of an electron having sufficient energy to cross the barrier of gate dielectric 7, under a given bias condition (drain-to-source voltage V_{ds}, gate-to-source voltage V_{gs}, body node bias, etc.), which is combined with the probabilities that such a hot carrier does not collide (and thus lose energy) on its path into and through gate dielectric 7. According to this approach, an estimate of gate injection current, which is the actual programming current, is based on these probabilities and on the peak electric field in the channel. The Hu article also describes that substrate current reliably predicts that peak electric field in the channel. As such, in conventional hot carrier injection programming models, substrate current commonly serves as a proxy for hot carrier injection. Conventional models exist for substrate current, as a function of drain-to-source voltage V_{ds}, and gate-to-source voltage V_{gs}.

To summarize, conventional SPICE models for floating gate transistors 2 in memory cell 5 of FIG. 1a are based on the modeling of substrate current I_{sub} as a function of drain-to-source voltage V_{ds} and gate-to-source voltage:

I_{sub}=f(V_{ds}, V_{gs})

This substrate current I_{sub} includes channel hot carriers, as well as substrate current conducted into the source and drain regions under bias. As described in the Hu article referenced above, because both the hot carrier injection and substrate current I_{sub} depend on the peak electric field in the channel, the gate injection current I_{gate} is modeled as a function of substrate current I_{sub}:

I_{gate}=f(I_{sub})

Typically, the relationship between gate injection current I_{gate} is modeled as a linear function of substrate current I_{sub}, with a slope based on the modeled collision probabilities of the hot carriers, and other factors including surface doping concentration. The charge Q_{FG} trapped at floating gate FG can be estimated as the integral over time of gate current I_{gate}:

$${Q}_{FG} = {\int }_{t} {I}_{gate} d t$$

The programmed state of the floating-gate transistor can be determined from the transistor model, including the effects of the trapped charge Q_{FG}.

### BRIEF SUMMARY OF THE INVENTION

Embodiments of this invention provide a method and system for modeling avalanche-induced hot carrier injection (HCI) floating gate transistors in a more accurate manner.

Embodiments of this invention provide such a method and system in which the model is not vulnerable to spurious programming events, while still modeling unintended programming caused by circuit conditions.

Embodiments of this invention provide such a method and system that is compatible with existing device and circuit models.

Other objects and advantages of embodiments of this invention will be apparent to those of ordinary skill in the art having reference to the following specification together with its drawings.

This invention may be implemented into a computerized system and method of operating such a system that includes models for floating-gate transistors in circuits to be simulated. The extent to which charge is trapped on the floating gate electrode of such a transistor is modeled by evaluating a gate injection current model parameter over time. To evaluate the gate injection current, a model for substrate current as a function of transistor bias is evaluated. That evaluated substrate current is then used to generate a non-quasi-static representation of the gate injection current. According to one embodiment of the invention, the non-quasi-static representation is an exponential voltage developed in an R-C circuit to which the substrate current is applied. The resulting voltage from the R-C circuit controls a voltage-controlled current source, which generates the modeled gate injection current value.

### BRIEF DESCRIPTION OF THE SEVERAL VIEWS OF THE DRAWING

FIG. 1a is an electrical diagram of a conventional memory cell including a floating-gate transistor.

FIG. 1b is a cross-sectional diagram illustrating the programming mechanism of avalanche-induced hot carrier injection in a conventional floating gate transistor.

FIG. 2a is an electrical diagram, in block and schematic form, of a non-volatile memory function including memory cells based on floating-gate transistors, in connection with which embodiments of the invention can be used.

FIG. 2b is a timing diagram illustrating the operation of the memory function of FIG. 2a.

FIG. 3a is an electrical diagram, in schematic form, of a model of a floating-gate transistor according to an embodiment of the invention.

FIG. 3b is a plot of read current versus programming pulse width, providing a comparative illustration of a conventional device model with a model of the floating-gate transistor programming mechanism according to an embodiment of the invention.

FIG. 4 is an electrical diagram, in block form, of a simulation system programmed to perform simulation of a circuit including floating-gate transistors modeled according to embodiments of this invention.

FIG. 5 is a flow diagram illustrating the operation of the simulation system of FIG. 4 in simulating the operation of a circuit including floating-gate transistors modeled according to embodiments of this invention.

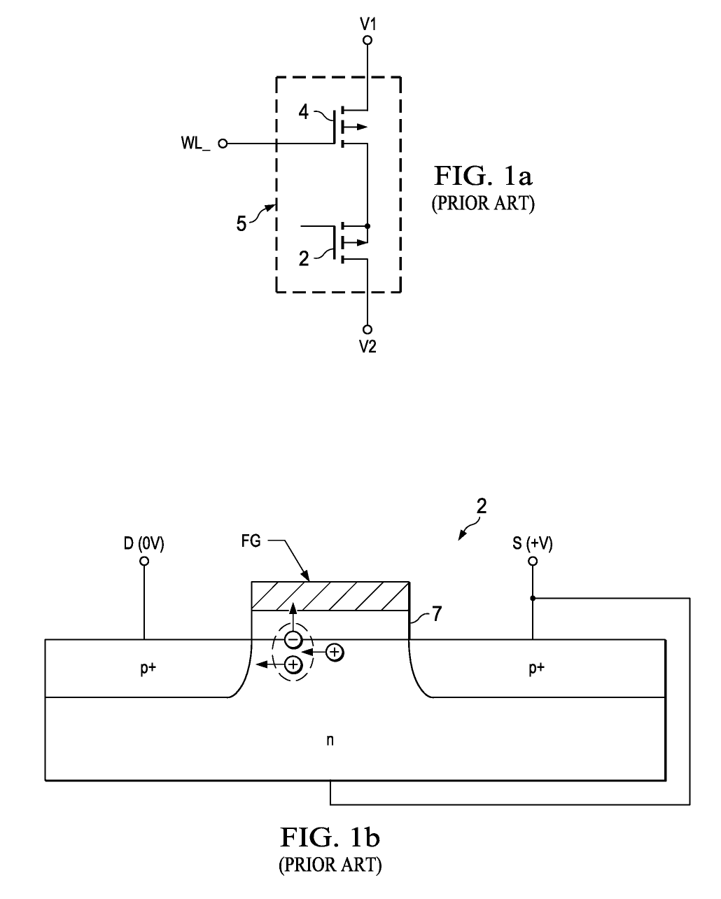

### DETAILED DESCRIPTION OF THE INVENTION

The present invention will be described in connection with particular embodiments, namely as implemented into the modeling of non-volatile memory cells for use in a simulation program such as the Simulation Program with Integrated Circuit Emphasis (SPICE), because it is contemplated that this invention will be especially beneficial when used in such a context. However, it is contemplated that this invention may be used to model other circuit elements in which hot carrier injection mechanisms are involved, and in connection with other simulation environments. Accordingly, it is to be understood that the following description is provided by way of example only, and is not intended to limit the true scope of this invention as claimed.

Theory of the Model

As discussed above in connection with the Background of the Invention, conventional SPICE models for floating-gate programmable transistors are based on the modeling of transistor substrate current, from which a gate injection current into the floating gate is derived. The substrate current is conventionally modeled as a function of the drain-to-source, gate-to-source, and body node voltages at the transistor, and the gate injection current is conventionally modeled as a time-invariant linear function of the substrate current. As a result, charge trapped at the floating gate of the device is modeled as a function of the bias voltages applied to the transistor terminals by the surrounding circuit environment.

It has been observed, in connection with this invention, that this conventional model is in error, insofar as the floating gate transistor is subjected to relatively short programming pulses. More specifically, it has been observed that the extent to which actual floating gate transistor devices are programmed by short programming pulses is less than that predicted by this conventional model. The reason for this deviation of simulation behavior from actual physical device performance has not heretofore been understood.

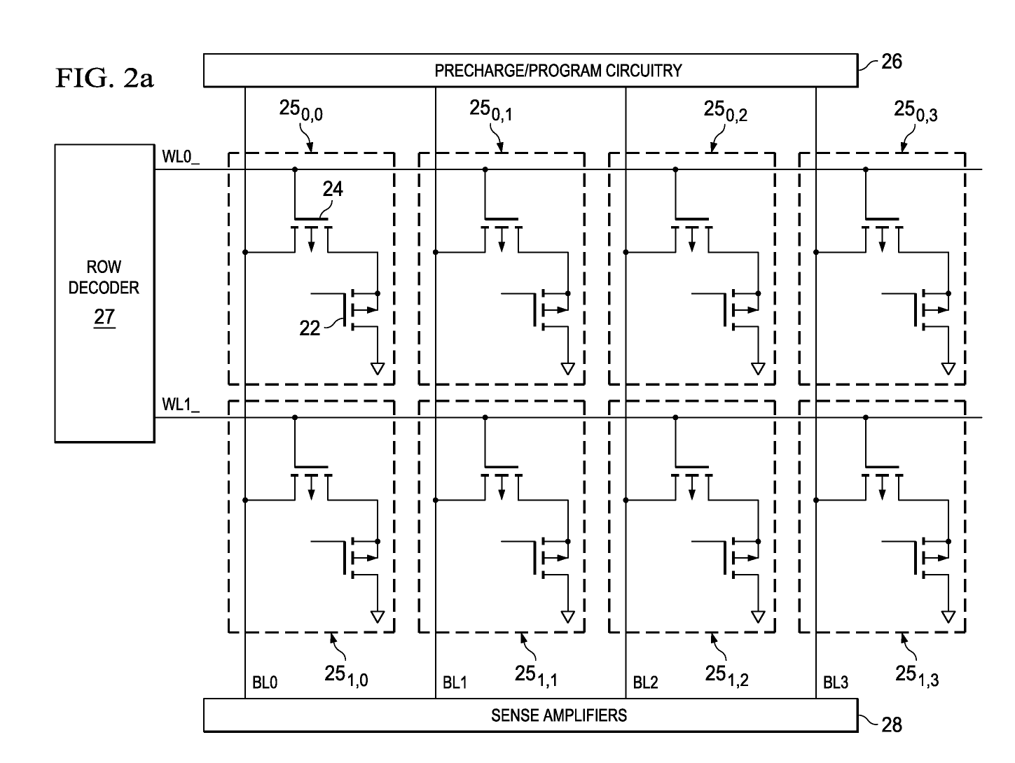

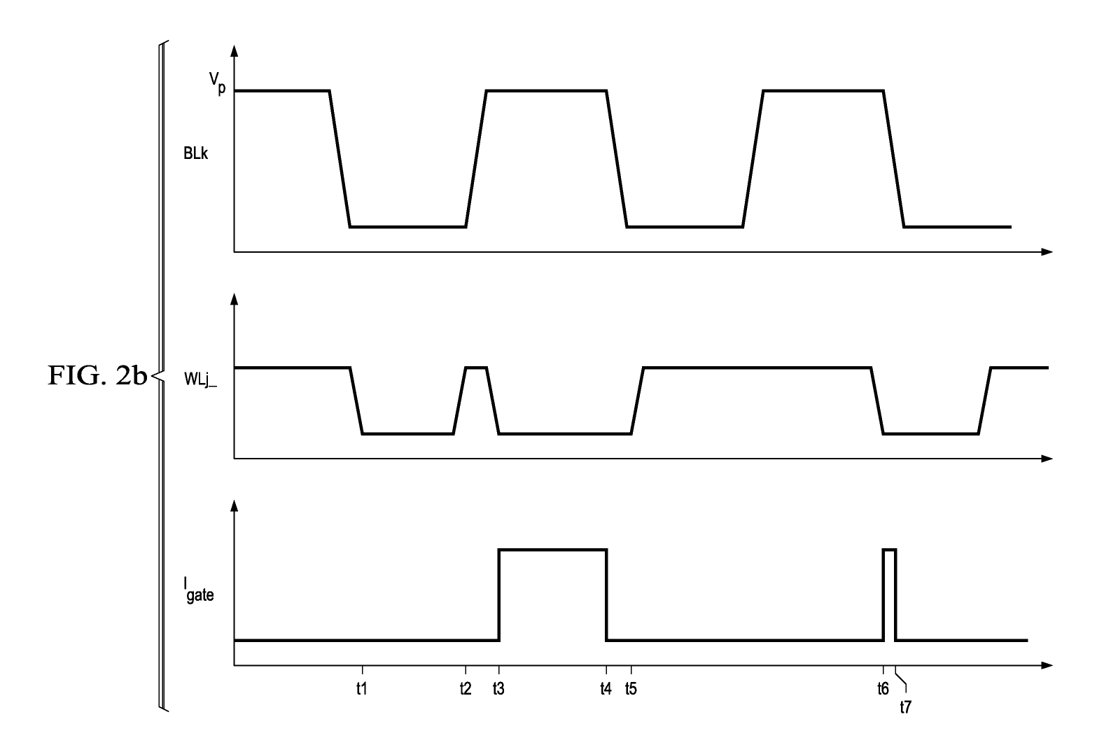

FIG. 2a illustrates an example of a circuit environment in which floating gate memory cells 25 are arranged in rows and columns, in a small memory array. Of course, conventional non-volatile memories will include many more programmable memory cells 25 than that shown in FIG. 2, as well as additional circuitry for addressing the desired memory cells 25 and communicating data therewith. In this simplified example, memory cells 25 are arranged in four columns, each associated with a corresponding bit line BL0 through BL3, and two rows, each associated with a corresponding word line WL0_, WL1_. Within a given memory cell 25_{j,k}, p-channel select transistor 24 has its source at corresponding bit line BLk, its gate connected to corresponding word line WLj_, and its drain connected to the source (and body node) of p-channel floating gate transistor 22; the drain of transistor 22 is at ground. Such a construction is especially useful in so-called “one-time programmable”, or OTP, memories, in which memory cells 25 will not be erased, once programmed. This construction can also be used in erasable non-volatile memory implementations, such as “flash” memories.

The circuit environment of memory cells 25 in this simplified example of FIG. 2a includes row decoder 27 for driving word lines WL0_, WL1_, in response to a received row address value. Precharge and programming circuitry 26 applies the appropriate voltage to bit lines BL0 through BL3, depending on the particular memory operation desired (read or program). Sense amplifiers 28 are coupled to the opposite end of bit lines BL0 through BL3, to sense the state of one or more selected memory cells in a given read cycle.

In operation, a read cycle consists of precharge and programming circuitry 26 precharging bit lines BL0 through BL3 to a desired voltage near the V_{dd} power supply voltage for the integrated circuit, followed by row decoder 27 driving active one of word lines WL0_, WL1_ (active low, in this example) in response to a received row address value. The programmed state of each memory cell 25 in the selected row will be reflected at the corresponding bit lines BL0 through BL3, and sensed by sense amplifiers 28 in the conventional manner. Programming of a selected memory cell 25_{j,k} is performed, in this simplified example, by application of a programming voltage Vₚ (typically well above the V_{dd} power supply voltage) to the corresponding bit line BLk, in combination with an active (low) level at the corresponding word line WLj_. This condition causes avalanche breakdown at the drain-to-channel junction of floating-gate transistor 22 of memory cell 25_{j,k}, resulting in charge becoming trapped at the floating gate, as described above.

FIG. 2b illustrates simplified examples of the possible timing of various levels in the operation of the memory of FIG. 2a. In the examples of FIG. 2b, the voltages at word line WLj_ and bit line BLk resulting from a computerized simulation of the memory of FIG. 2a are shown, along with the response to those simulation voltages of gate injection current I_{gate}, based on the conventional model for that current described above in connection with the Background of the Invention. In this example, prior to time t1, word line WLj_ is inactive (high) while bit line BLk is at programming voltage Vₚ; as such, no gate injection current I_{gate} is provided by the conventional model. Conversely, beginning at time t3 and continuing until time t4, bit line BLk is at programming voltage Vₚ while word line WLj_ is active (low). In this condition, a sufficiently high (Vₚ) voltage appears at the source of floating gate transistor 22 in memory cell 25_{j,k} that the conventional model reports a substantial gate injection current I_{gate} during the interval. Upon the voltage of bit line BLk driven low at time t4 (followed by word line WLj_ going inactive at time t5), the gate injection current I_{gate} ceases.

Depending on the particular circuit conditions, including transient response based on modeled parasitic impedances, the simulation of certain circuit operation can show unintended timing overlap. In the example of FIG. 2b, during the brief duration from time t6 to time t7, the simulation shows bit line BLk remaining at programming voltage Vₚ briefly after word line WLj_ is taken active low. This event can correspond to unanticipated delay in de-assertion of the programming voltage, for example. During this brief interval, the source of floating gate transistor 22 in memory cell 25_{j,k} will be at or near programming voltage Vₚ. In this event, the conventional model of gate injection current I_{gate} described above shows a brief pulse between time t6 and t7, resulting from the high source-to-drain voltage at transistor 22 during that time. As a result, this conventional model indicates that some amount of charge is trapped at the floating gate electrode of transistor 22 of memory cell 25_{j,k}, due to the unintended overlap of bit line BLk and word line WLj_. Significant programming has been shown by the conventional model as occurring in response to programming pulses as short as 0.1 μsec.

This unintended programming behavior shown by simulation, using the conventional floating gate transistor programming model, has caused alarm to the circuit designer. If certain circuit conditions resulting in brief programming pulses in fact cause unintended programming, the threshold voltage of the floating gate transistors will be unintentionally altered. If the designer relies on the simulation result of the example of FIG. 2b, that designer will change the circuit design (for example, increasing the drive capability of precharge and programming circuitry 26) or physical layout (increasing the line width of bit lines BLk to reduce resistance and capacitance, thus improving switching speed), to ensure that the overlap shown in FIG. 2b does not result. In many cases, the design solutions to this problem will increase chip area of the resulting integrated circuit, thus increasing the manufacturing cost of the eventual device.

As mentioned above, however, it has been discovered, according to this invention, that the spurious unintended programming indicated by the conventional floating gate transistor model as shown in FIG. 2b does not in fact occur in the case of extremely short programming pulses. More specifically, it has been observed, in connection with this invention, that the spurious programming indicated by the conventional model for programming pulses of 0.5 μsec or shorter does not occur to the predicted extent in actual physical transistors.

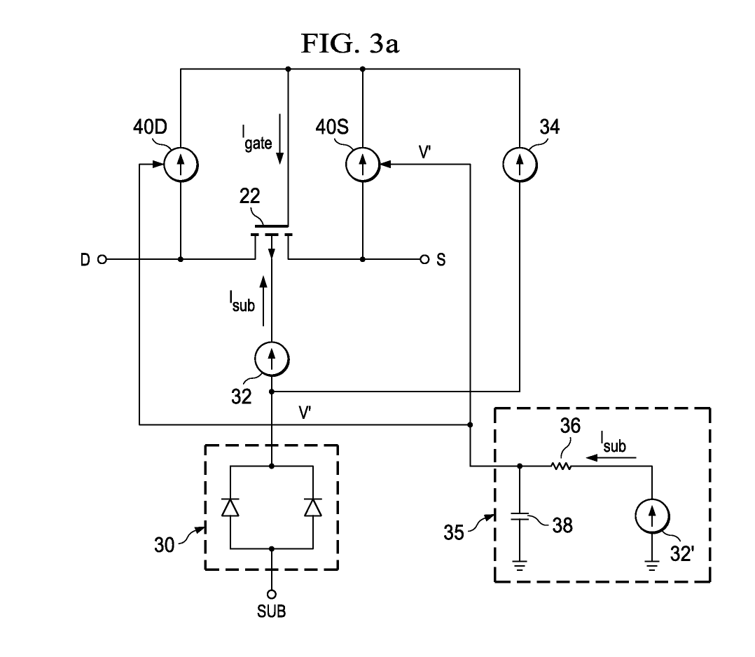

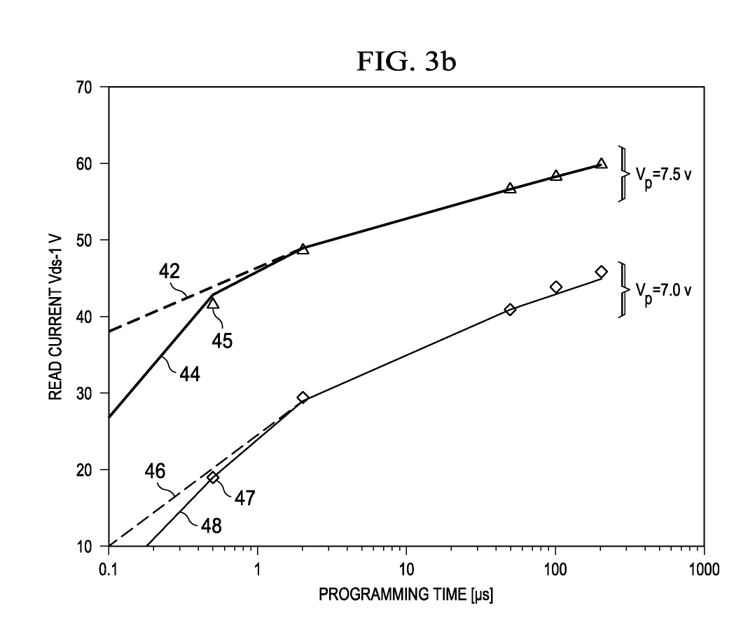

According to this invention, it is believed that the physical mechanism of hot carrier injection, as initiated or caused by avalanche junction breakdown, is a non-quasi-static mechanism. In other words, it is believed that some finite build-up time following the onset of avalanche junction breakdown is required for the generation of hot carriers. This behavior of the mechanism is believed to be similar to the non-quasi-static behavior of avalanche photodiodes, as has been reported in the art. In the case of hot carrier injection into the floating gate electrode, this non-quasi-static build-up time is reflected by the gate injection current I_{gate} being suppressed for very short programming pulses, such as that shown in FIG. 2b and discussed above. Embodiments of this invention take advantage of this realization, by incorporating a non-quasi-static expression into the model of the gate injection current for floating-gate transistors 22 in memory cells 25, as will now be described in connection with FIGS. 3a and 3b.

In connection with embodiments of this invention. FIG. 3a is an electrical schematic diagram illustrating a model of gate injection current I_{gate} for p-channel floating-gate MOS transistor 22. In this example, the programming mechanism (i.e., the mechanism by way of which charge can be trapped at the floating gate electrode of transistor 22) is avalanche-induced hot carrier injection. Also in this example, transistor 22 does not have a control gate electrode, but is contemplated to be implemented in series with a corresponding select transistor 24, as described above relative to memory cells 25 of FIG. 2a.

Embodiments of this invention can also be used in connection with other types of floating-gate programmable transistors and memory cells, including single-transistor memory cells in which the floating-gate transistor includes both a floating gate electrode and a control gate electrode, as known in the art. Other types of floating-gate transistors, particularly those programmed by way of hot carrier injection, are contemplated to also utilize the models corresponding to embodiments of this invention.

In the example of the device model shown in FIG. 3a, the input stimuli correspond to the voltages applied to drain D, source S, and substrate SUB at each point in time in the simulated interval. The model shown in FIG. 3 is useful in modeling the programming of transistor 22 in response to its circuit environment, as reflected by the drain, source, and substrate voltages; the programming that can be evaluated in this regard includes both intended programming (i.e., storing a desired programmed data state at transistor 22), and also the extent to which spurious, unintended, programming occurs under certain circuit conditions.

The model of FIG. 3a includes well diode element 30, which represents the diode present at the metallurgical junction between the p-type integrated circuit substrate and the n-type well region within which the source and drain regions of transistor 22 reside. This diode is thus taken into account by the model of transistor 22, as affecting the device behavior for a given substrate bias voltage applied to terminal SUB. In this p-channel example, current source 32 represents a calculated body current I_{body}, which in this embodiment of the invention is a function of the substrate bias at terminal SUB (via junction diode element 30), and also a function of the voltages at drain D and source S. In this example, no control gate is present in transistor 22, and as such no gate voltage is directly implicated in the modeling of body current I_{body}. According to this embodiment of the invention, body current I_{body} is modeled in the conventional manner as described in the Hu article for substrate current, as a time-invariant function of the drain, source, and well voltages. To summarize:

I_{body}=f(V_{D}, V_{S}, V_{SUB}−Vₜ)

where voltages V_{D}, V_{S}, V_{SUB} are the voltages at drain D, source S, and substrate SUB, respectively, and where voltage Vₜ is the threshold voltage drop established by junction diode element 30. In general, it is contemplated that any conventional model for body current in a MOS transistor, into which the physical parameters specific to the modeled construction of transistor 22 are incorporated, can be used to evaluate body current I_{body}. According to embodiments of this invention, body current I_{body} serves as a proxy for impact ionization current.

Gate injection current I_{gate} is modeled by three components in this embodiment of the invention. One component of gate injection current I_{gate} is represented in FIG. 3a by current source 34. This particular component of the gate current establishes the initial condition of transistor 22 for a particular simulated event. Specifically, current source 34 in the model injects charge into the floating gate electrode as an initial condition for those simulated events in which programming is not being called for, such as a read of transistor 22 from an already-programmed data state. For purposes of evaluating a programming gate injection current (whether intentional or spurious), this current from current source 34 is not of importance.

In programming events, intentional or spurious, the programming current is represented in this model by current sources 40S, 40D. In this embodiment of the invention, each of current sources 40S, 40D is a voltage-controlled current source function coupled on one side to source S and drain D, respectively, and coupled on another side to the floating gate electrode. The control voltage to each of current sources 40S, 40D is voltage V′ generated by non-quasi-static circuit 35. In this embodiment of the invention, non-quasi-static circuit 35 generates control voltage 35 as a time function of body current I_{body}. As described above, a finite build-up time is believed to control hot carrier injection induced by avalanche breakdown. As such, non-quasi-static circuit 35 is provided in this model of floating gate transistor 22 to incorporate this build-up time effect, in the evaluated expression for gate injection current I_{gate}.

In the example of this embodiment of the invention shown in FIG. 3a, non-quasi-static circuit 35 is driven by current source 32′, which is a current source driving a current equal to body current I_{body} as evaluated by the time-invariant function represented by current source 32. This value of body current I_{body} is applied to a representation of an R-C circuit, constituted by the series connection of resistor 36 and capacitor 38; the opposite plate of capacitor 38 is at ground in this example. Control voltage V′ is represented by the voltage across capacitor 38 in this embodiment of the invention. And, to incorporate the desired non-quasi-static build-up effect, the initial condition of capacitor 38 is fully discharged, so that control voltage V′ builds up from zero volts upon application of body current I_{body} from current source 32′. According to fundamental circuit analysis, control voltage V′ will increase exponentially in response to body current I_{body} (which, as indicated above, is time invariant in response to constant drain, source, and well voltages), with a time constant defined by the resistance R and capacitance C values of resistor 36 and capacitor 38, respectively. To summarize, in this example, control voltage V′ is modeled in the form:

V′(t)∝R·I_{body}(1−e^{-Δt/RC})

considering that the final voltage V′ will correspond to the voltage drop across resistor 36 for body current I_{body} (assuming current source 32′ as ideal). In this expression, the time variable Δt expresses the time elapsed since the onset of junction breakdown (or the time elapsed since the beginning of a programming pulse condition). For the example of FIG. 2b, this time variable Δt would be the elapsed time after time t3 (Δt=t−t3), or after time t6 (Δt=t−t6) The particular resistance R and capacitance C included within non-quasi-static circuit 35 can be empirically determined to provide the best fidelity between model and measured stored charge, based on experiment and measurement, or may alternatively be estimated from material and layout parameters.

Alternatively, other implementations of non-quasi-static circuit 35 may be used, in which control voltage V′ is generated in a manner consistent with the build-up of hot carrier injection following avalanche junction breakdown. Such other implementations may include higher-order exponential expressions, whether realizable by circuit elements or not (i.e., realizable only by way of complex expressions). However, it is contemplated that a simple first order R-C circuit representation will generally provide a faithful representation of the programming of floating-gate transistor 22, useful in a wide range of circuit applications.

Control voltage V′ generated by non-quasi-static circuit 35 in this embodiment of the invention controls the currents sourced by current sources 40S, 40D from source S and drain D, respectively, into the floating gate of transistor 22 as gate injection current I_{gate}. The gate injection current component sourced by each of current sources 40S, 40D is contemplated to be a linear function of the time-varying control voltage V′, such that the overall expression of gate injection current I_{gate} can be generically represented as:

I_{gate}(t)=m·V′(t)+k

where slope m and constant k are determined from experiment or theory.

In order to determine the extent to which charge due to hot carrier injection has been trapped at the floating gate electrode of transistor 22, the evaluated gate injection current I_{gate}(t) is integrated over time to evaluate the charge transferred during the event.

$${Q}_{trapped} = {\int }_{t} {I}_{gate} ( t ) d t$$

This integration may be carried out by any applicable method, ranging from simple summing of the current I_{gate} for each sample period within the pulse interval and multiplying by the sample period, to numerical integration or other integration methods.

Simulation and experiment have shown that embodiments of this invention better represent the programming effects of short bias pulses applied to floating-gate transistors such as transistor 22, than does the conventional time-invariant model for gate injection current. FIG. 3b illustrates two comparative examples of the inventive and current models, as compared with experimental results, at two different programming voltages Vₚ for a typical floating-gate transistor constructed according to modern technology. In FIG. 3b, the programming effect is measured by the read current conducted by cell 25 at a bit line voltage of 1 volt, following the application of a programming pulse Vₚ of a given duration to that cell 25. As such, and considering that floating-gate transistor 22 in this example is a p-channel transistor, electrons trapped at the floating gate electrode will decrease the effective threshold voltage of transistor 22, increasing the current conducted by transistor 22 for a given source-drain bias from that conducted in its erased state (i.e., no trapped electrons at the floating gate).

Plot 42 illustrates the modeled read current for floating-gate transistor 22, according to the conventional model in which gate injection current I_{gate} is a time-invariant function of the applied voltages, at a programming voltage Vₚ of 7.5 volts; conversely, plot 44 illustrates the modeled read current evaluated according to the non-quasi-static programming current model of the embodiment of the invention described above relative to FIG. 3a. As evident from FIG. 3b, the model according to this embodiment of the invention shown by plot 44 predicts less programming (i.e., reduced conduction by transistor 22), than that shown by plot 42 for the conventional model, for programming pulses of duration less than about 1 μsec. This reduced programming effect stems from the exponential expression for control voltage V′ in response to the modeled body current I_{body}, and the resulting delay in gate injection current. As evident from FIG. 3b, experimental measurement point 45 for a programming pulse of about 0.5 μsec in duration agrees better with plot 44 according to embodiments of this invention, than with the conventional model that predicts a substantially greater programming effect resulting from that short pulse. The deviation between plots 42, 44 increases even further as the programming pulse duration shortens below 0.5 μsec.

A similar difference between the conventional and inventive models is also present at a lower programming voltage, such as at voltage Vₚ=7.0 volts, as shown by plots 46, 48 of FIG. 3b. Again, plot 46 represents the predicted programming effect (expressed as read current conducted by transistor 22) according to the conventional model, while plot 48 corresponds to the programming effect predicted by the non-quasi-static model according to embodiments of this invention. As again shown in FIG. 3b, at short programming pulses below about 1 μsec, the two predictions deviate from one another. However, experiment and measurement of an actual device validates the improved accuracy of the non-quasi-static model according to embodiments of this invention, as shown by the close correspondence of measurement point 47, for an actual device in response to a programming pulse of about 0.5 μsec in duration, to the result predicted by the non-quasi-static model shown by plot 48.

According to embodiments of this invention, this improved non-quasi-static model for programming current into the gate of a floating-gate transistor is readily incorporated into a modeling and simulation system, by way of which the designer of an integrated circuit including programmable floating-gate transistors can evaluate the programming behavior of the device, both in response to intended programming pulses and also in the event that circuit conditions apply brief pulses of programming-level voltages to those devices.

Modeling and Simulation System

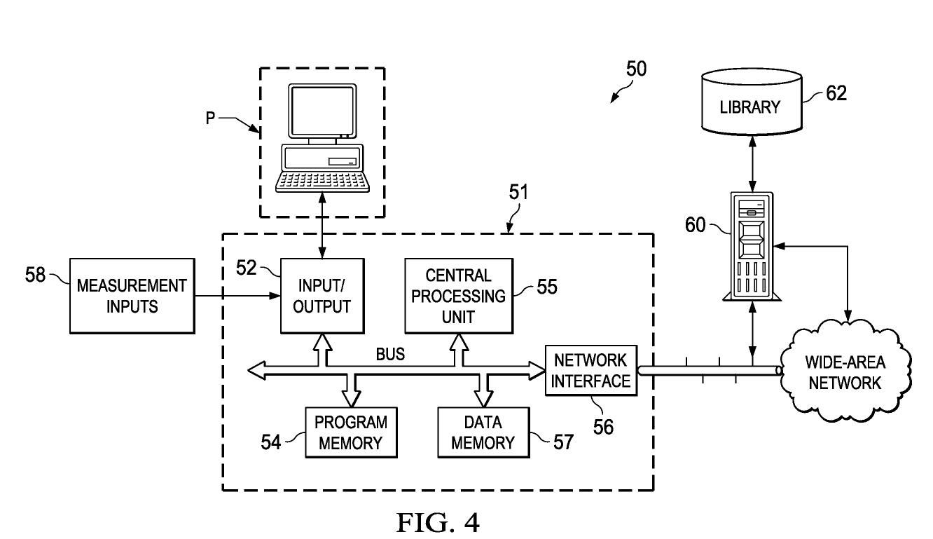

The theory of the model used to represent the response of floating-gate transistor 22 to various circuit conditions conducive to hot carrier injection of charge into the floating gate electrode, according to this embodiment of the invention, has been described. Referring now to FIG. 4, simulation system 50 for deriving and storing the model, and for applying that model in the simulation of an electronic circuit including floating-gate transistor 22, according to embodiments of this invention, will now be described.

FIG. 4 illustrates the construction of simulation system 50 according to an example of an embodiment of the invention, which performs the operations described in this specification to apply a non-quasi-static model of non-volatile transistor 22 into an electronic circuit, and to simulate the behavior of that electronic circuit. In this example, simulation system 50 is as realized by way of a computer system including workstation 51 connected to server 60 by way of a network. Of course, the particular architecture and construction of a computer system useful in connection with this invention can vary widely. For example, simulation system 50 may be realized by a single physical computer, such as a conventional workstation or personal computer, or alternatively by a computer system implemented in a distributed manner over multiple physical computers. Accordingly, the generalized architecture illustrated in FIG. 4 is provided by way of example only.

As shown in FIG. 4, workstation 51 includes central processing unit 55, coupled to system bus BUS. Also coupled to system bus BUS is input/output interface 52, which refers to those interface resources by way of which peripheral functions P (e.g., keyboard, mouse, display, etc.) interface with the other constituents of workstation 51. Central processing unit 55 refers to the data processing capability of workstation 51, and as such may be implemented by one or more CPU cores, co-processing circuitry, and the like. The particular construction and capability of central processing unit 55 is selected according to the application needs of workstation 51, such needs including, at a minimum, the carrying out of the functions described in this specification, and also including such other functions as may be desired to be executed by simulation system 50. In the architecture of modeling and simulation system 10 according to this example, program memory 54 and data memory 57 are coupled to system bus BUS.

Program memory 54 stores the computer instructions to be executed by central processing unit 55 in carrying out those functions. More specifically, program memory 54 is a computer-readable medium storing executable computer program instructions according to which the operations described in this specification are carried out by simulation system 50, specifically by central processing unit 55 of workstation 51. Alternatively, these computer program instructions may be stored at and executed by server 60, in the form of a “web-based” application, upon input data communicated from workstation 51, to create output data and results that are communicated to workstation 51 for display or output by peripherals P in a form useful to a human user. Data memory 57 provides memory resources of the desired type useful as data memory for storing input data and the results of processing executed by central processing unit 55. Of course, this memory arrangement is only an example, it being understood that data memory 57 and program memory 54 may be included within a unified physical memory resource, or distributed in whole or in part outside of workstation 51. In addition, as shown in FIG. 4, measurement inputs 58 that are acquired from laboratory tests and measurements, or as design parameters, are input via input/output function 52, and stored in a memory resource accessible to workstation 51, either locally or via network interface 56.

Network interface 56 of workstation 51 is a conventional interface or adapter by way of which workstation 51 accesses network resources on a network. As shown in FIG. 4, the network resources to which workstation 51 has access via network interface 56 includes server 60, which resides on a local area network, or a wide-area network such as an intranet, a virtual private network, or over the Internet, and which is accessible to workstation 51 by way of one of those network arrangements and by corresponding wired or wireless (or both) communication facilities. In this embodiment of the invention, server 60 is a computer system, of a conventional architecture similar, in a general sense, to that of workstation 51, and as such includes one or more central processing units, system buses, and memory resources, network interface functions, and the like. Library 62 is also available to server 60 (and perhaps workstation 51 over the local area or wide area network), and stores model calculations, previous model results, actual electrical measurements for use in correlation with current models, and other archival or reference information useful in simulation system 50. Library 62 may reside on another local area network, or alternatively be accessible via the Internet or some other wide area network. It is contemplated that library 62 may also be accessible to other associated computers in the overall network.

Of course, the particular memory resource or location at which the measurements, library 62, and program memory 54 physically reside can be implemented in various locations accessible to simulation system 50. For example, these data and program instructions may be stored in local memory resources within workstation 51, within server 60, or in remote memory resources that are network-accessible to these functions. In addition, each of these data and program memory resources can itself be distributed among multiple locations, as known in the art. It is contemplated that those skilled in the art will be readily able to implement the storage and retrieval of the applicable measurements, models, and other information useful in connection with this embodiment of the invention, in a suitable manner for each particular application.

According to this embodiment of the invention, by way of example, program memory 54 stores computer instructions executable by central processing unit 55 to carry out the functions described in this specification, by way of which the behavior of a modeled example of floating-gate transistor 22 can be evaluated in a given circuit environment. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. For example, it is contemplated that the model of floating-gate transistor 22 described herein is especially useful when applied to an electronic circuit simulation using a simulation environment based on the well-known Simulation Program with Integrated Circuit Emphasis, commonly referred to as SPICE, originated at the Electronics Research Laboratory of the University of California, Berkeley. Many commercial versions of the SPICE program are now available in the industry, including several versions that are internal or proprietary to integrated circuit manufacturers.

It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloaded as encoded information on an electromagnetic carrier signal, for example in the form of a software package from which the computer-executable software instructions were installed by simulation system 50 in the conventional manner for software installation.

Operation of the Model in Evaluating Circuit Behavior

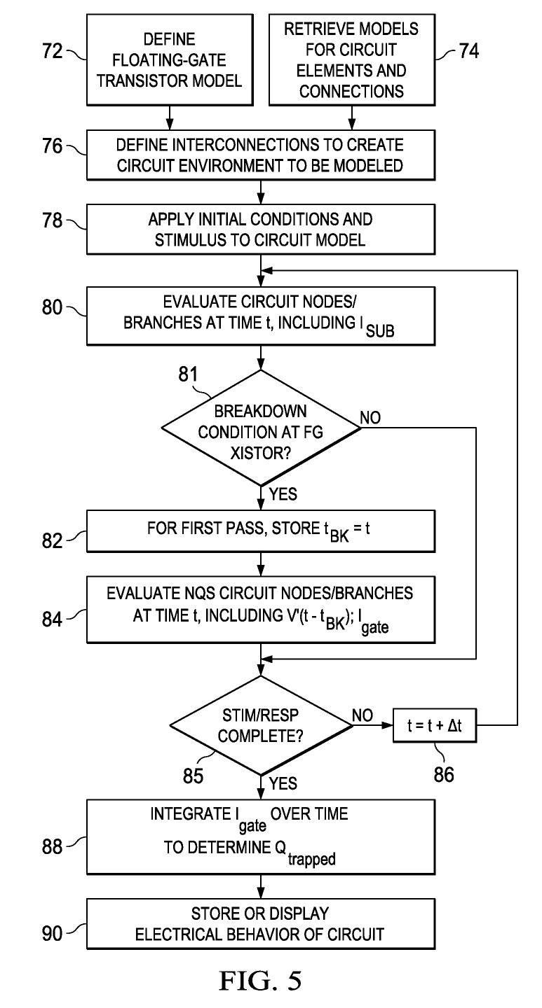

FIG. 5 illustrates an example of the operation of simulation system 50 according to an embodiment of this invention. This example evaluates a circuit including one or more floating-gate transistors, programmable by avalanche-induced hot carrier injection, and modeled according to embodiments of this invention, as described above. It is contemplated that each of the process steps performed in connection with this description of the operation of simulation system 50 will be executed, under either user or program control, by the appropriate functions and components of simulation system 50, depending on the particular architecture. More specifically, it is contemplated that this operation of simulation system 50 will be performed by central processing unit 55 or such other component in simulation system 50 in the execution of program instructions stored in program memory 54 or in some other memory resource of simulation system 50. It is of course contemplated that the specific manner in which simulation system 50 performs these operations can be defined by those skilled in the art having reference to this specification, as appropriate for the particular architecture of simulation system 50 and the desired interface between simulation system 50 and the human user.

In process 72, the particular parameters for modeling the floating-gate transistors to be included in the simulated circuit are defined, and stored in the memory of simulation system 50. According to the embodiment of the invention described above in connection with FIG. 3a, process 72 includes the selection of the various parameters and functions within the equivalent circuit representation. The functions defined in process 72 include the time-invariant function represented by current source 32 in defining body current I_{body} as a function of the drain, source, and substrate voltages, and the linear functions of control voltage V′ represented by current sources 40S, 40D defining their output current. Process 72 also includes the selection of resistance R for resistor 36, and capacitance C for capacitor 38 in non-quasi-static circuit 35. Alternatively, as mentioned above, non-quasi-static circuit 35 may be constructed or modeled according to another non-quasi-static function or expression to reflect the avalanche build-up effect in the hot carrier injection mechanism. If variations in the device size or other construction are present among multiple floating-gate transistors in the circuit to be modeled, process 72 will of course define the model parameters and functions, as the case may be, for each such class of floating-gate transistor.

As such, in the simulation process of FIG. 5 according to this embodiment of the invention, models for circuit elements other than the floating-gate transistors (models for which were defined in process 72) are retrieved from library 62 or another appropriate memory resource in simulation system 50, in process 74. To the extent appropriate, models for interconnection elements (conductors, etc.) to be incorporated into the simulated circuit are also retrieved in process 74. For both the circuit elements, and also the interconnection types, it is contemplated that the retrieved models will also include models of the parasitic elements to be considered in the simulation.

As known in the art for SPICE and similar simulation environments, the simulation of an electronic circuit including the modeled floating-gate transistors is based on a set of circuit elements that are associated with selected “nodes” in an overall “netlist” that specifies the circuit being simulated. Each circuit element is specified by a model, which specifies the simulated behavior of the circuit element in response to stimuli applied to that circuit element at its nodes; some nodes in the circuit will serve as inputs to the circuit being simulated, while other nodes will serve as the “output” nodes, namely as the nodes under investigation by the simulation in response to the stimuli applied at the input nodes. As such, in process 76, the interconnections among the various modeled circuit elements, including floating-gate transistors, are defined, to create the circuit environment to be simulated in this instance. This circuit environment will include the function to be performed by the modeled floating-gate transistors, whether as part of a non-volatile memory resource (shown in a simplified version in FIG. 3a), as a programmable control register, as part of a programmable trim circuit for an analog circuit function, or the like. In any case, the circuit model defined in process 76 includes the node and branch connections among those elements for which models were retrieved and defined, arranged according to the design of the circuit being simulated.

Following the definition and retrieval of the applicable models, and the definition of the circuit environment to be simulated including those modeled circuit elements, the simulation of electronic circuits including floating-gate transistors can now be carried out. Those skilled in the art with familiarity with SPICE or other computer-based electronic circuit simulation programs or packages, and having reference to this specification, will be readily able to apply the models of floating-gate transistors produced in the manner described above to simulate the behavior of such devices and circuits in a wide variety of conditions, and in a wide variety of circuit applications. This simulation begins, in the example of FIG. 5, with process 78 in which initial conditions are applied at certain nodes, defining the initial state of the circuit at time “0” in the simulation, and in which the stimulus to the circuit is applied as desired for the behavior to be analyzed by way of the simulation. As known in the art, the particular analysis involved can vary widely, including such analysis types as steady-state (“DC”) analysis, small-signal (“AC”) analysis, stability analysis, and the analysis of the transient response of the circuit under simulation.

An example of the simulation of a circuit including floating-gate transistors modeled as described above in connection with FIGS. 3a and 3b, by way of simulation system 50 of FIG. 4, is illustrated in the remainder of FIG. 5. Upon application of the stimulus to the modeled circuit in process 78, simulation system 50 evaluates the nodes and branches of that modeled circuit at a given time t, in a first instance of process 80. Considering the definition of the floating-gate transistor model resulting from process 72, the evaluation of process 80 includes evaluation of body current I_{body} into one or more modeled floating-gate transistors at this time t.

Decision 81 evaluates whether the condition of one or more of floating-gate transistors in the simulated circuit is in a breakdown condition, specifically an avalanche breakdown condition at which hot carrier injection may occur. It is contemplated that an empirical or theoretical threshold can be defined for decision 81, for example a threshold voltage differential between the voltage at the source or body node of the floating-gate transistor, and the voltage at its drain. If breakdown is not present (decision 81 is “no”), decision 85 is executed by simulation system 50 to determine whether the desired simulation is complete (e.g., whether the response to the applied stimulus has reached a steady state). If not (decision 85 is “no”), the simulation time t is advanced by a time step Δt in process 86, and evaluation process 80 is repeated at the new simulation time point t.

If a breakdown condition is present at the current simulation time t (decision 81 is “yes”) for at least one floating-gate transistor, then the evaluation of hot carrier injection current into the gate of that transistor begins. If the current instance of the breakdown condition is first detected at the current simulation time t, the current simulation time t is stored as breakdown time t_{BK}, in process 82. This initial breakdown time t_{BK} is involved in the non-quasi-static model, for example as described above relative to FIG. 3a.

Once in breakdown (decision 81 is “yes”), process 84 is then performed by simulation system 50 to evaluate the non-quasi-static nodes and branches in the simulated circuit at the current simulation time t. This evaluation process 84 includes evaluation of gate injection current I_{gate}, which of course is the charge per unit time being injected into the floating gate of the transistor currently in breakdown. According to the model of FIG. 3a described above, this evaluation of gate injection current I_{gate} includes the evaluation, at simulation time t, of:

V′(t)∝R·I_{body}(1−e^{-(t-tBK)/RC})

and of:

I_{gate}(t)=m·V′(t)+k

slope m and constant k, and also any constant of proportionality in the expression for control voltage V′, were defined in the floating-gate transistor models, in process 72. This value of gate injection current I_{gate} at simulation time t is stored in memory (e.g., data memory 54), and decision 85 is then executed by simulation system 50 to determine whether the simulation is complete, as described above.

Upon incrementing of simulation time t in process 86, so long as the non-volatile transistor remains in its breakdown condition (decision 81 remains “yes”), then evaluation process 84 is repeated to evaluate the non-quasi-static gate injection current I_{gate} at the incremented simulation time. Of course, within the same breakdown event (i.e., programming pulse, whether intended or spurious), the time differential t−t_{BK} will increase, thus increasing the evaluated control voltage V′ and thus also increasing the resulting gate injection current I_{gate}, according to the models of the embodiment of the invention described above. On the other hand, upon cessation of the breakdown event (decision 81 returns a “no” result in a subsequent pass), the gate injection current I_{gate} is assumed to be zero in this embodiment of the invention, which is believed to be consistent with the cessation of the hot carrier injection mechanism in the absence of breakdown at the drain junction. Of course, other treatment of the end of the programming pulse (e.g., a decay in gate injection current cessation from the end of breakdown) may alternatively be incorporated into the model, if desired.

Upon completion of the particular simulation event (decision 85 returns a “yes” decision), data memory 57 of simulation system will contain estimates of gate injection current I_{gate} acquired at sample times within an interval in which a corresponding floating-gate transistor was in breakdown, as described above. These gate injection current I_{gate} values will reflect a non-quasi-static behavior over time, relative to the initiation of the injection inducing event (e.g., avalanche breakdown at the drain junction), according to embodiments of this invention. The desired result of the simulation, however, is the amount of charge trapped at the floating gate electrode of the modeled transistor, which is obtained in process 88 according to embodiments of this invention. In process 88, an integration of the gate injection current I_{gate} values evaluated in process 84 is performed, to arrive at an estimate of the total charge transferred to the floating gate electrode by hot carrier injection, over the duration of the simulation. As discussed above, this integration may be performed in any one of a number of ways including summing of the evaluated gate injection current I_{gate}(t) values and multiplying the sum by the sample period (time step Δt), or other numerical techniques. The result of process 88 is an estimate of the trapped charge Q_{trapped} at the floating gate:

$${Q}_{trapped} = {\int }_{t} {I}_{gate} ( t ) d t$$

This trapped charge will determine the effect of the hot carrier injection on the state of the transistor. Of course, the determination of trapped charge Q_{trapped} trapped will be performed for each floating-gate transistor in the simulated circuit, in response to the particular circuit conditions at those transistors over the simulated time period.

Upon completion of process 88 in this example, the simulation results are stored by simulation system 50 in a memory resource such as library 62 or data memory 57, displayed or printed on an output device, or both, in process 90. Considering that the models and simulation described above are used to determine the programmed state of one or more floating-gate transistors in a given circuit, it is contemplated that the value of trapped charge Q_{trapped} determined in process 88 for each of the transistors will itself be used in subsequent simulations, such as simulation of a read cycle of a memory cell (e.g., cell 25 described above) in which trapped charge Q_{trapped} is present at the floating gate of the corresponding transistor 22, and from which the read current can be determined (see, e.g., FIG. 3b described above).

### IN CONCLUSION

Embodiments of this invention provide many advantages useful in the design and manufacture of integrated circuits that include memories, registers, trim bits, or other circuits and circuit elements that include floating-gate metal oxide semiconductor (MOS) transistors. According to this invention, the accuracy of the models used in simulation of such circuits is substantially improved over conventional floating-gate transistor models. In particular, according to embodiments of this invention, a floating-gate transistor model includes non-quasi-static behavior in the hot carrier injection mechanism, particularly as induced by avalanche breakdown at the drain junction of the floating-gate transistor. Inclusion of this non-quasi-static expression for gate injection current has been observed, in connection with this invention, to closely model the effect of avalanche build-up time in the generation of hot carriers. As such, the spurious programming predicted by conventional floating-gate transistor models to result from very short programming pulses is removed from the simulation results, while still predicting true spurious (i.e., unintended) programming for those programming pulses of sufficient duration. The improved model and simulation results will allow more aggressive circuit design, and thus maximizing integrated circuit performance and minimizing chip area and thus manufacturing cost.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of operating a computer system to simulate the behavior of an electronic circuit including a floating-gate metal-oxide-semiconductor (MOS) transistor, comprising the steps of:
retrieving, from a memory resource in the computer system, a model of the electronic circuit, including models of a plurality of circuit elements and connections among those circuit elements;
applying initial conditions and an assigned stimulus to nodes of the model of the electronic circuit, including the floating-gate MOS transistor;
evaluating a body current for the floating-gate MOS transistor as a function of voltages applied to its terminals responsive to the applying step;
generating a non-quasi-static representation of gate injection current to the floating gate of the floating-gate MOS transistor responsive to the evaluated substrate;
evaluating trapped charge at the floating gate based on the gate injection current over a time variable; and
generating a simulation output based on the evaluated trapped charge.

2. The method of claim 1, wherein the step of generating the non-quasi-static representation of gate injection current comprises:
determining a breakdown time corresponding to onset of avalanche breakdown in the floating-gate MOS transistor; and
estimating gate injection current as a function of time elapsed from the breakdown time.

3. The method of claim 2, wherein the step of generating the non-quasi-static representation of gate injection current comprises:
defining a model of an R-C circuit;
evaluating a voltage across the capacitor in the R-C circuit responsive to application of the body current to the R-C circuit model beginning at a time corresponding to the breakdown time;
evaluating the gate injection current as a linear function of the evaluated voltage.

4. The method of claim 1, wherein the step of evaluating trapped charge at the floating gate comprises:
estimating an integration of the gate injection current over a time duration corresponding to a programming pulse.

5. The method of claim 1, further comprising:
evaluating a threshold voltage for the floating-gate MOS transistor based on the evaluated trapped charge at the floating gate;
wherein the step of generating a simulation output comprises:
simulating the behavior of the electronic circuit based on the floating-gate MOS transistor having the threshold voltage as evaluated in the evaluating step.

6. A non-transitory computer-readable medium storing a computer program that, when executed on a computer system, causes the computer system to perform a sequence of operations for simulating the behavior of an electronic circuit including a floating-gate metal-oxide-semiconductor (MOS) transistor, the sequence of operations comprising:
retrieving, from a memory resource in the computer system, a model of the electronic circuit, including models of a plurality of circuit elements and connections among those circuit elements;
applying initial conditions and an assigned stimulus to nodes of the model of the electronic circuit, including the floating-gate MOS transistor;
evaluating a body current for the floating-gate MOS transistor as a function of voltages applied to its terminals responsive to the applying step;
generating a non-quasi-static representation of gate injection current to the floating gate of the floating-gate MOS transistor responsive to the evaluated substrate;
evaluating trapped charge at the floating gate based on the gate injection current over a time variable; and
generating a simulation output based on the evaluated trapped charge.

7. The computer-readable medium of claim 6, wherein the operation of generating the non-quasi-static representation of gate injection current comprises:
determining a breakdown time corresponding to onset of avalanche breakdown in the floating-gate MOS transistor; and
estimating gate injection current as a function of time elapsed from the breakdown time.

8. The computer-readable medium of claim 7, wherein the operation of generating the non-quasi-static representation of gate injection current comprises:
defining a model of an R-C circuit;
evaluating a voltage across the capacitor in the R-C circuit responsive to application of the body current to the R-C circuit model beginning at a time corresponding to the breakdown time;
evaluating the gate injection current as a linear function of the evaluated voltage.

9. The computer-readable medium of claim 6, wherein the operation of evaluating trapped charge at the floating gate comprises:
estimating an integration of the gate injection current over a time duration corresponding to a programming pulse.

10. The computer-readable medium of claim 6, further comprising:
evaluating a threshold voltage for the floating-gate MOS transistor based on the evaluated trapped charge at the floating gate;
wherein the operation of generating a simulation output comprises:
simulating the behavior of the electronic circuit based on the floating-gate MOS transistor having the threshold voltage as evaluated in the evaluating step.
